(19) United States
(12) Patent Application Publication
(10) Pub. No.: US 2010/0081013 A1
(43) Pub. Date: Apr. 1, 2010

(54) MAGNETIC DISK SUBSTRATE AND MAGNETIC DISK

(75) Inventors: Kenichi NISHIMORI, Amphur Muang (TH); Tadashi TOMONAGA, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: HOYA CORPORATION, Tokyo (JP); HOYA GLASS DISK (THAILAND) LTD., Lamphun (TH)

(21) Appl. No.: 12/566,288

(22) Filed: Sep. 24, 2009

(30) Foreign Application Priority Data
Sep. 26, 2008 (JP) 2008-247161
Sep. 3, 2009 (JP) 2009-203694

(51) Int. Cl. G11B 5/706

(52) U.S. Cl. 428/848.2

(57) ABSTRACT

In a magnetic disk substrate being annular and having a first and a second main surface, (1) surface roughness measured by an atomic force microscope having a resolution of 256×256 pixels per 2 μm square and/or (2) the number of foreign substances detected to have sizes of 0.1 μm or more and 1.0 μm or less upon detection of scattered light from the magnetic disk substrate when laser light with a wavelength of 405 nm is irradiated with a spot size of 5 μm at a laser power of 25 mW differ/differs between the first and the second main surfaces. Only the first main surface has a surface quality usable as a magnetic recording surface. The number of the foreign substances detected to have the sizes of 0.1 μm or more and 1.0 μm or less upon detection of the scattered light from the magnetic disk substrate when the laser light with the wavelength of 405 nm is irradiated with the spot size of 5 μm at the laser power of 25 mW is 400 or less per 30 cm² on the second main surface.

This application is based upon and claims the benefit of priority from Japanese Patent Application No. 2008-247161, filed on Sep. 26, 2008, the disclosure of which is incorporated herein in its entirety by reference.

### BACKGROUND OF THE INVENTION

This invention relates to a substrate for a magnetic disk (hereinafter referred to as a “magnetic disk substrate”) and a magnetic disk.

As a magnetic recording medium adapted to be mounted in a hard disk drive (HDD), there is a magnetic disk. The magnetic disk is fabricated by stacking a magnetic layer and a protective layer over a substrate in which a NiP film is coated on a metal plate made of an aluminum-magnesium alloy or the like, a glass substrate, or a ceramic substrate. In order to meet the needs of markets and with the development of the microfabrication technique in recent years, the reduction in size and the increase in density of magnetic disks have advanced and, nowadays, the storage capacity reaches up to, for example, 40 GB in a 1.8-inch magnetic disk on both sides thereof.

Following the improvement in recording density of HDDs as described above, the spacing (hereinafter referred to as a “flying height”) between a read/write head (hereinafter referred to as a “head”) and a magnetic disk has become very narrow, i.e. several tens of nm to several nm. Accordingly, if a minute uneven defect exists on the magnetic disk, the head is brought into contact with the magnetic disk, thus causing failure of the HDD. This minute uneven defect is a damage-based defect such that a disk substrate material itself is damaged in some way, or a foreign substance-based defect such as residue of abrasive grains due to polishing carried out for improving the flatness of a magnetic disk substrate or a foreign substance that adheres/remains in cleaning, drying, or the like. Particularly, the latter is caused by the fact that particles/contaminants that adhere to an end face of a glass substrate during end face processing are released from the end face and adhere again to main surfaces of the glass substrate in a subsequent cleaning process.

For the purpose of preventing the foreign substance-based defect due to the contaminants on the end face as described above, a proposal has been made to polish an end face of a glass substrate after shaping the glass substrate using a cutter or drill, thereby making it difficult for foreign substances/contaminants to remain on the end face of the glass substrate (see, e.g. JP-A-H11-221742).

On the other hand, in the case of a magnetic disk improved in storage capacity as described above, there is a case where the storage capacity only on one side (e.g. 20 GB) thereof is sufficient depending on its use, and there is such a need. This is because a HDD using a magnetic disk having a magnetic recording surface only on one side thereof (hereinafter referred to as a “one-side magnetic disk”) requires only a single head and thus it is possible to achieve a reduction in thickness, weight, and cost as compared with a HDD using a magnetic disk having magnetic recording surfaces on both sides thereof (hereinafter referred to as a “double-side magnetic disk”). Further, there is also an advantage in that, in the manufacture of a one-side magnetic disk, it is necessary to stack a magnetic layer and so on only on a surface (hereinafter referred to as a “surface A”) to be used as a magnetic recording surface and therefore the manufacturing processes thereof can be simplified as compared with those of a double-side magnetic disk.

Further, inasmuch as a one-side magnetic disk substrate can allow a minute uneven defect on a surface (hereinafter referred to as a “surface B”) not to be used as a magnetic recording surface, it is possible to improve the yield as compared with a double-side magnetic disk substrate in which a minute uneven defect on either one of surfaces makes it a defective product.

As described above, the minute uneven defect on the surface B of the one-side magnetic disk substrate does not become a cause for a defective product because it does not cause a contact between a magnetic disk and a head. However, if residue of abrasive grains due to polishing of both main surfaces of the one-side magnetic disk substrate or foreign substances that adhere in cleaning, drying, or the like (hereinafter collectively referred to as “foreign substances”) exist on the surface B, when cleaning the substrate before stacking a magnetic layer and so on on the surface A, there is a possibility that (1) the foreign substances contaminate the surface A due to re-adhesion thereof during cleaning or (2) the foreign substances contaminate a cleaning apparatus itself. Further, with respect to an obtained magnetic disk, it may happen that the foreign substances on the surface B are scattered due to the rotation of the magnetic disk and adhere to a magnetic head in a seek test on the surface A, thereby causing a read/write error. Further, in an actual inspection process of the magnetic disk formed with the magnetic layer and so on, there is a case where an inspection head is also provided for the surface B and, in this case, if the foreign substances remain in large numbers on the surface B, there is a possibility that the inspection head is contaminated or damaged when the inspection head is in close vicinity to the surface B.

### SUMMARY OF THE INVENTION

This invention has been made in view of the above-mentioned problems.

It is an object of this invention to provide a magnetic disk substrate that can prevent contamination of a surface, to be used as a magnetic recording surface, in substrate cleaning in the manufacture of a one-side magnetic disk.

It is another object of this invention to provide a magnetic disk substrate that can prevent contamination of a cleaning apparatus in substrate cleaning in the manufacture of a one-side magnetic disk.

It is still another object of this invention to provide a magnetic disk substrate that can reduce read/write errors in a magnetic disk seek test in the manufacture of a one-side magnetic disk.

It is yet still another object of this invention to provide a magnetic disk substrate that can reduce contamination or damage of an inspection head in the manufacture of a one-side magnetic disk.

In order to achieve the above-mentioned objects, the present inventors have considered (1) to prevent contamination of a surface to be used as a magnetic recording surface, (2) to prevent contamination of a cleaning apparatus, (3) to reduce read/write errors in a magnetic disk seek test, and (4) to reduce contamination or damage of an inspection head in the manufacture of a one-side magnetic disk by suppressing the number of foreign substances to a predetermined number on a surface B, not to be formed with a magnetic layer and so on, of the one-side magnetic disk.

A magnetic disk substrate according to this invention is a magnetic disk substrate being annular and having a first and a second main surface, wherein (1) surface roughness measured by an atomic force microscope having a resolution of 256×256 pixels per 2 μm square and/or (2) the number of foreign substances detected to have sizes of 0.1 μm or more and 1.0 μm or less upon detection of scattered light from the magnetic disk substrate when laser light with a wavelength of 405 nm is irradiated with a spot size of 5 μm at a laser power of 25 mW differ/differs between the first and the second main surfaces, and wherein only the first main surface has a surface quality usable as a magnetic recording surface and the number of the foreign substances detected to have the sizes of 0.1 μm or more and 1.0 μm or less upon detection of the scattered light from the magnetic disk substrate when the laser light with the wavelength of 405 nm is irradiated with the spot size of 5 μm at the laser power of 25 mW is 400 or less per 30 cm² on the second main surface.

In addition, a magnetic disk according to this invention comprises the above-mentioned magnetic disk substrate and a laminated film including at least a magnetic layer and formed only on the first main surface of the magnetic disk substrate.

In this event, no film may be formed on the second main surface.

Further, an offset film preferably may be formed on the second main surface for offsetting a film stress generated when the laminated film is formed on the first main surface.

In addition, the magnetic disk substrate may be made of a multi-component glass, and an elution preventing film preferably may be formed on the second main surface for preventing elution of ions forming the multi-component glass to the surface of the magnetic disk substrate.

### BRIEF DESCRIPTION OF THE DRAWINGS

FIG. 1 is a diagram showing the structure of a magnetic disk substrate according to an embodiment of this invention;

FIG. 2 is a diagram showing the relationship between the number of foreign substances on a surface B of a magnetic disk substrate according to the embodiment of this invention and the head contamination level on the surface A side thereof; and

FIG. 3 is a diagram showing a schematic structure of an apparatus for detecting foreign substances on a magnetic disk substrate.

### DESCRIPTION OF THE EXEMPLARY EMBODIMENT

Hereinbelow, an embodiment of this invention will be described using figures, Examples, and so on. It is to be noted that these figures, Examples, and so on and a description are for illustrative purposes only and are not intended to limit the scope of this invention in any aspect. It is needless to say that other embodiments can belong to the category of this invention as long as they agree with the gist of this invention.

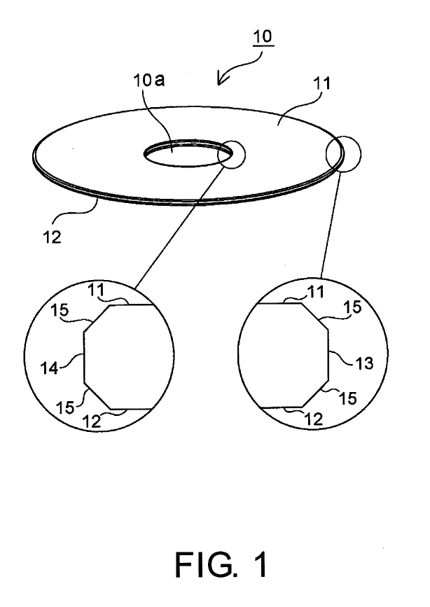

FIG. 1 is a perspective view showing the structure of a magnetic disk substrate 10 according to the embodiment of this invention. The magnetic disk substrate 10 according to this embodiment is an annular one-side magnetic disk substrate having a circular hole 10a. The magnetic disk substrate 10 has a first main surface 11 which is substantially flat and will be used as a magnetic recording surface, a second main surface 12 which is substantially flat and will not be used as a magnetic recording surface, an outer peripheral end face 13 as an outer peripheral end portion, and an inner peripheral end face 14 as an inner peripheral end portion. Hereinafter, the first main surface 11 will also be referred to as a surface A and the second main surface 12 will also be referred to as a surface B. Chamfered faces 15 are formed between the outer peripheral end face 13 and the surfaces A and B 11 and 12, respectively, and between the inner peripheral end face 14 and the surfaces A and B 11 and 12, respectively.

The surface A 11 is a surface to be used as the magnetic recording surface and is a surface which is stacked with a magnetic layer and so on in a magnetic disk and over which a read/write head flies in a HDD.

Therefore, uneven defects on the surface A 11 are removed to the extent that does not impede the flight of the head. On the other hand, the surface B 12 is a surface not to be used as the magnetic recording surface. Therefore, uneven defects on the surface B can be allowed to some degree. However, the number of foreign substances on the surface B 12 is set to less than a predetermined number so as not to affect the manufacture of a magnetic disk.

As a material of the magnetic disk substrate 10, use can be made of an aluminosilicate glass, a sodalime glass, a borosilicate glass, an aluminum-magnesium alloy, or the like.

Particularly, the aluminosilicate glass can be preferably used as the material of the magnetic disk substrate 10 because it can be chemically strengthened and it can provide the magnetic disk substrate 10 excellent in flatness of the main surfaces 11 and 12 and in substrate strength. In this embodiment, a description will be given of the case where the magnetic disk substrate 10 is a glass substrate.

The manufacture of the magnetic disk substrate 10 includes processes such as Material Processing Process and First Lapping Process; End Portion Shaping Process (coring process for forming a hole and chamfering process for forming chamfered faces at end portions (outer peripheral end portion and inner peripheral end portion) (chamfered face forming process)); End Face Polishing Process (outer peripheral end portion and inner peripheral end portion); Second Lapping Process; Main Surface Polishing Process (first and second polishing processes); and Chemical Strengthening Process.

Hereinbelow, the respective processes in the manufacture of the magnetic disk substrate 10 will be described. The order of the processes may be appropriately changed.

(1) Material Processing Process and First Lapping Process

First, in the material processing process, lapping (grinding) was applied to surfaces of a plate-like glass to obtain a glass base member and then the glass base member is cut, thereby cutting out a glass disk from the glass base member. As the plate-like glass, one of various plate-like glasses can be used. The plate-like glass can be manufactured, for example, by a known manufacturing method such as a press method, a float method, a downdraw method, a redraw method, or a fusion method using a molten glass as a material. If the press method is used among these methods, the plate-like glass can be manufactured at low cost.

In the first lapping process, lapping is applied to both main surfaces, i.e. a surface A 11 and a surface B 12, of the plate-like glass, thereby obtaining a disk-shaped glass base member. The lapping can be carried out using a double-side lapping machine employing a planetary gear mechanism with the use of alumina-based free abrasive grains. Specifically, the lapping is carried out by pressing lapping surface plates onto both surfaces of the plate-like glass from the upper and lower sides, supplying a grinding fluid containing the free abrasive grains onto the main surfaces of the plate-like glass, and relatively moving them to each other. By this lapping, a glass substrate having flat main surfaces can be obtained.

(2) End Portion Shaping Process (Coring Process for Forming a Hole and Chamfering Process for Forming Chamfered Faces at End Portions (Outer Peripheral End Portion and Inner Peripheral End Portion) (Chamfered Face Forming Process))

In the coring process, using, for example, a cylindrical diamond drill, an inner hole 10a is formed at a central portion of the glass substrate, thereby obtaining an annular glass substrate 10. In the chamfering process, grinding is applied to an inner peripheral end face 14 and an outer peripheral end face 13 using diamond grindstones, thereby carrying out predetermined chamfering to form chamfered faces 15.

(3) Second Lapping Process

In the second lapping process, second lapping is applied to both main surfaces 11 and 12 of the obtained glass substrate 10 in the same manner as in the first lapping process. By performing this second lapping process, minute irregularities formed on the main surfaces 11 and 12 in the cutting-out process or an end face polishing process as a previous process can be removed in advance, so that it becomes possible to complete a subsequent polishing process of the main surfaces 11 and 12 in a short time.

(4) End Face Polishing Process

In the end face polishing process, the outer peripheral end face 13 and the inner peripheral end face 14 of the glass substrate 10 are mirror-polished by a brush polishing method. In this event, as polishing abrasive grains, use can be made of, for example, a slurry (free abrasive grains) containing cerium oxide abrasive grains. By this end face polishing process, the end faces of the glass substrate 10 are finished to a mirror surface state that can prevent precipitation of sodium and potassium.

(5) Main Surface Polishing Process (First Polishing Process)

The first polishing process is first carried out as a main surface polishing process. The first polishing process mainly aims to remove cracks or strains remaining on both main surfaces 11 and 12 during the above-mentioned lapping processes. In this first polishing process, both main surfaces 11 and 12 are polished using a double-side polishing machine having a planetary gear mechanism with the use of a hard resin polisher. Cerium oxide abrasive grains can be used as a polishing agent.

The glass substrate 10 having been subjected to the first polishing process is cleaned with neutral detergent, pure water, IPA (isopropyl alcohol), and so on.

(6) Main Surface Polishing Process (Final Polishing Process)

Then, the second polishing process is carried out as a final polishing process. The second polishing process aims to finish both main surfaces 11 and 12 into mirror surfaces. In the second polishing process, both main surfaces 11 and 12 are mirror-polished using a double-side polishing machine having a planetary gear mechanism with the use of a soft resin foam polisher.

As a slurry, use can be made of cerium oxide abrasive grains, colloidal silica, or the like finer than the cerium oxide abrasive grains used in the first polishing process.

In this final polishing process, it is preferable that the surface, facing downward, of the glass substrate 10 in the state of being placed in the double-side polishing machine be the surface A (i.e. the surface to be used as the magnetic recording surface) 11 of the one-side magnetic disk substrate 10.

This is because the upper surface of the glass substrate 10 placed in the double-side polishing machine is more likely to be subjected to the occurrence of cracks due to biting of floating substances in the polishing environment or the occurrence of processing surface damage due to handling or the like as compared with the lower surface of the glass substrate 10 and, therefore, if the upper surface is set to be the surface B 12 in advance, the probability of producing a defective product decreases in the manufacture of a one-side magnetic disk.

In the processes up to (5) Main Surface Polishing Process (First Polishing Process), both main surfaces 11 and 12 of the glass substrate have been handled with no distinction therebetween, but in (6) Main Surface Polishing Process (Final Polishing Process) and subsequent processes, both main surfaces, i.e. the surface A 11 and the surface B 12, of the glass substrate will be handled with distinction therebetween as described above.

The glass substrate 10 having been subjected to the second polishing process is cleaned with neutral detergent, pure water, IPA, and so on.

(7) Chemical Strengthening Process

In the chemical strengthening process, chemical strengthening is applied to the glass substrate 10 having been subjected to the above-mentioned lapping processes and polishing processes. As a chemical strengthening solution for use in the chemical strengthening, use can be made of, for example, a mixed solution of potassium nitrate (60%) and sodium nitrate (40%). The chemical strengthening is carried out by heating the chemical strengthening solution to 300° C. to 400° C., preheating the cleaned glass substrate 10 to 200° C. to 300° C., and immersing the glass substrate 10 in the chemical strengthening solution for 3 hours to 4 hours. In order to chemically strengthen the entire main surfaces 11 and 12 of the glass substrate 100, the immersion is preferably carried out in the state where a plurality of glass substrates 10 are placed in a holder so as to be held at their end faces.

By performing the immersion process in the chemical strengthening solution as described above, lithium ions and sodium ions in the surface layers of the glass substrate 10 are replaced by sodium ions and potassium ions having relatively large ionic radii in the chemical strengthening solution, respectively, so that the glass substrate 10 is strengthened.

The chemically strengthened glass substrate 10 is cleaned with sulfuric acid and then cleaned with pure water, IPA, and so on.

(8) Inspection Process

The present inventors have paid attention to the relationship between the number of foreign substances on the surface B 12 and contamination of an inspection head on the surface A 11 side.

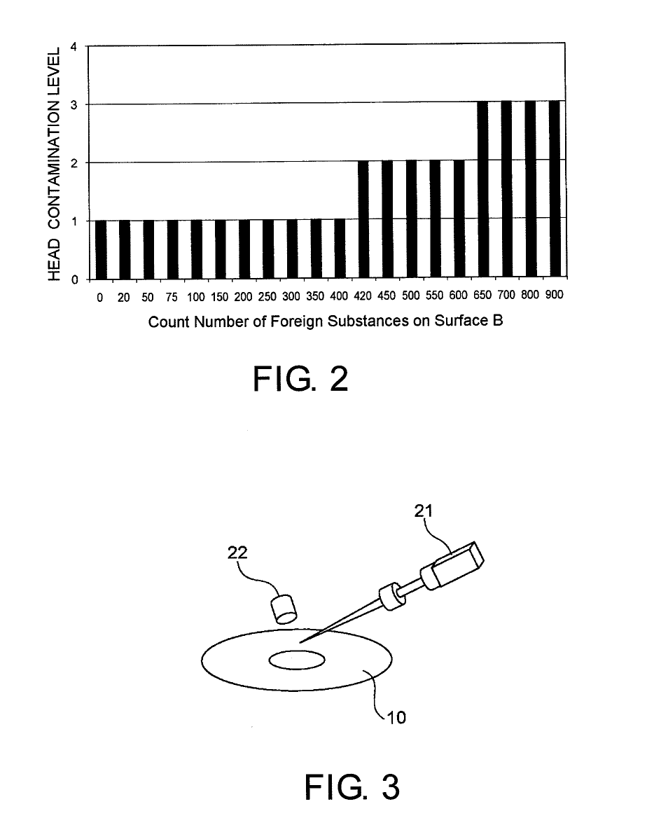

FIG. 2 is a characteristic diagram showing the relationship between the number of foreign substances on the surface B 12 and contamination of an inspection head (head contamination level) on the surface A 11 side. The head contamination level is an index of dirt on an inspection head before a glide test.

As seen from FIG. 2, the head contamination level becomes 2 when the number (count number) of foreign substances on the surface B 12 is 420 and the head contamination level becomes 3 when the number (count number) of foreign substances on the surface B 12 is 650. That is, it is seen that, even in the state where no foreign substance exists on the surface A 11, when a certain number of foreign substances exist on the surface B 12, the foreign substances re-adhere due to the cleaning process to contaminate the surface A 11.

Therefore, with respect to the number (count number) of foreign substances for adjusting the foreign substances on the surface B 12, it is preferably determined depending on the head contamination level. For example, in order to satisfy the head contamination level 1, it is preferable to set the number (count number) of foreign substances on the surface B 12 to 400 or less. In order to adjust the number (count number) of foreign substances on the surface B 12 as described above, cleaning is carried out, for example, under a condition that chemical solution cleaning such as acid/alkaline/detergent cleaning, pure water cleaning, and so on are combined stepwise.

It is to be noted that the number (count number) of foreign substances on the surface B 12 is the number of foreign substances in the state before cleaning and before forming a laminated film including at least a magnetic layer on the magnetic recording surface (surface A) 11. This number can be counted using an optical defect inspection apparatus (Optical Surface Analyzer: OSA) as shown in FIG. 3. The apparatus shown in FIG. 3 comprises a defect detection probe laser 21 and a detector 22 for detecting scattered light in substantially all directions when laser light is irradiated onto the glass substrate 10. In the apparatus shown in FIG. 3, if the laser spot size is set to, for example, 5 μm, inasmuch as the laser wavelength is short and the power is large, the defect detection sensitivity can be made high.

More specifically, with respect to the number (count number) of foreign substances on each of the surface A 11 and the surface B 12, it is judged based on the number of foreign substances having predetermined sizes which are detected based on scattered light from the glass substrate 10 when laser light with a wavelength of 405 nm is irradiated with a spot size of 5 μm at a laser power of 25 mW using the apparatus shown in FIG. 3. Specifically, as a judgment criterion for the surface B 12, a judgment is made as to whether the number of foreign substances detected to have sizes of 0.1 μm or more and 1.0 μm or less is about 13 or less per 1 cm² (400 or less per surface of a 2.5-inch magnetic disk). (This example corresponds to the number of foreign substances per one-side area (about 30.04 cm²) of a magnetic disk having an outer diameter of 65 mm and an inner diameter of 20 mm.)

By counting the number of foreign substances under such conditions, the correlation between the number of foreign substances on the surface B 12 and the contamination state of the surface A 11 as shown in FIG. 2 is observed.

Herein, it is important to accurately perform the detection of foreign substances using a predetermined apparatus as described above. With respect to the size of foreign substances, it is preferably, for example, 0.1 μm or more and 1.0 μm or less in consideration of the magnetic properties and so on required for a 2.5-inch magnetic disk with a high recording density of 120 GB or more on one side. As a judgment criterion for the surface A 11, it is necessary to satisfy the quality (the size and number of foreign substances) that enables formation of a magnetic recording film (perpendicular magnetic recording layer) thereon and that is required for a magnetic disk so that the surface A 11 is required to have extremely high quality (cleanness) as compared with the surface B 12.

(9) Magnetic Disk Manufacturing Process (Process of Forming a Recording Layer and So On)

On the surface A 11 of the glass substrate 10 obtained through the above-mentioned processes, for example, an adhesive layer, a soft magnetic layer, a nonmagnetic underlayer, a perpendicular magnetic recording layer, a protective layer, and a lubricating layer are formed in this order, thereby manufacturing a perpendicular magnetic recording disk.

As a material of the adhesive layer, use can be made of a Cr alloy or the like. As a material of the soft magnetic layer, use can be made of a CoTaZr-group alloy or the like.

As the nonmagnetic underlayer, use can be made of a granular nonmagnetic layer or the like. As the perpendicular magnetic recording layer, use can be made of a granular magnetic layer or the like.

As a material of the protective layer, use can be made of hydrogenated carbon or the like.

As a material of the lubricating layer, use can be made of fluororesin or the like.

More specifically, the above-mentioned layers are formed such that, for example, using an in-line sputtering apparatus, an adhesive layer of CrTi, a soft magnetic layer of CoTaZr/Ru/CoTaZr, a granular nonmagnetic underlayer of CoCrSiO₂, a granular magnetic layer of CoCrPt—SiO₂.TiO₂, and a protective layer of hydrogenated carbon are formed in this order on the glass substrate 10 and, further, a lubricating layer of perfluoropolyether is formed by a dipping method.

It is not necessary to form a film on the surface B 12 side. However, if a laminated film including a magnetic layer is formed on the surface A 11 while no film is formed on the surface B 12, there is a case where the balance of film stress is lost between the surface A 11 and the surface B 12 depending on materials of the laminated film formed on the surface A 11 so that a magnetic disk is warped.

Taking this into account, it is preferable to form an offset film on the surface B 12 for offsetting the film stress generated when the laminated film is formed on the surface A 11.

As a material of the offset film, use can be made of one of the materials of the layers formed on the surface A 11, for example, a Cr alloy. The thickness of the offset film can be suitably set to a value that enables the film to exhibit the above-mentioned function.

Particularly when the magnetic disk substrate 10 is made of a multi-component glass, it is preferable to form on the second main surface (surface B) 12 an elution preventing film for preventing elution of ions forming the multi-component glass to the substrate surface.

As a material of the elution preventing film, use can be made of Ti, Cr, carbon, or the like. The thickness of the elution preventing film can be suitably set to a value that enables the film to exhibit the above-mentioned function.

The offset film and the elution preventing film may be used jointly.

There is a possibility that the foreign substances remaining on the surface B 12 of the magnetic disk substrate 10 are once removed and then re-adhere to the substrate 10 in cleaning before the film formation or are not fully removed by head burnishing to remain on the substrate 10, thus damaging an inspection head in a glide test or a certification test. In this invention, inasmuch as the number of foreign substances remaining on the surface B 12 is set to a predetermined number or less, it is possible to reduce contamination of a cleaning apparatus or contamination or damage of an inspection head in the manufacture of a one-side magnetic disk. Further, it is possible to reduce read/write errors in a magnetic disk seek test.

Next, a description will be given of an Example carried out for clarifying the effect of this invention, wherein a glass substrate is used as a magnetic disk substrate 10.

### EXAMPLE

First, a molten aluminosilicate glass was formed into a disk shape by direct pressing using upper, lower, and drum molds, thereby obtaining an amorphous plate-like glass member (blank). In this event, the diameter of the blank was 66 mm. Then, first lapping was applied to both main surfaces of the blank and then, using a cylindrical core drill, processing (coring) was carried out to form a hole 10a at a central portion of the blank, thereby obtaining an annular glass substrate 10. Then, a chamfering process (chamfered face forming process) was carried out to form chamfered faces 15 at end portions (outer peripheral end portion 13 and inner peripheral end portion 14) and then second lapping was carried out.

Then, the outer peripheral end portion 13 of the glass substrate 10 was mirror-polished by a brush polishing method. In this event, as polishing abrasive grains, use was made of a slurry (free abrasive grains) containing cerium oxide abrasive grains.

Then, the mirror-polished glass substrate 10 was washed with water. Consequently, the outer diameter and the inner diameter of the glass substrate 10 became 65 mm and 20 mm, respectively, thereby obtaining a substrate for use in a 2.5-inch magnetic disk.

Then, a first polishing process was applied as a main surface polishing process to both main surfaces 11 and 12 of the glass substrate 10. In the first polishing process, a double-side polishing machine was used as a polishing machine. As polishing pads in this polishing machine, soft suede pads were used. Cerium abrasive grains were used as a polishing agent. Polishing conditions were such that the processing surface pressure was set to 130 g/cm² and the processing rotational speed was set to 22 rpm. Consequently, the arithmetic mean roughness Ra of the glass substrate 10 became about 1.5 nm.

Then, in the state where the second main surface (surface B) 12, not to be used as a recording surface, of the glass substrate 10 was masked, a second polishing process was applied only to the first main surface (surface A) 11 to be used as a recording surface. In this second polishing process, a double-side polishing machine was used as a polishing machine. As polishing pads in this polishing machine, soft suede pads (Asker C hardness: 54, compressive deformation amount: 476 μm or more, density: 0.53 g/cm³ or less) were used. Cerium abrasive grains having an average grain size of 100 nm were used as a polishing agent. Polishing conditions were such that the processing surface pressure was set to 60 g/cm² and the processing rotational speed was set to 20 rpm. Consequently, the arithmetic mean roughness (surface roughness measured by an atomic force microscope having a resolution of 256×256 pixels per 2 μm square) Ra of the first main surface (surface A) 11, to be used as a recording surface, of the glass substrate 10 became 0.12 nm.

The glass substrate 10 having been subjected to the second polishing process was immersed in a KOH solution and cleaned for 120 seconds with the application of an ultrasonic wave, then scrub-cleaned for 4 seconds using an alkaline cleaning solution, then cleaned using highly diluted sulfuric acid and the above-mentioned alkaline cleaning solution, and then subjected to IPA steam drying.

Then, the glass substrate 10 having been subjected to the cleaning and drying as described above was chemically strengthened. The chemical strengthening was carried out by preparing a chemical strengthening solution in the form of a mixture of potassium nitrate (60%) and sodium nitrate (40%), heating this chemical strengthening solution to 380° C., and immersing the cleaned glass substrate 10 in the chemical strengthening solution for about 4 hours. Then, this chemically strengthened glass substrate 10 was subjected to acid cleaning, alkaline cleaning, and pure water cleaning in this order.

Particularly with respect to the surface B 12 of the glass substrate 10, cleaning was carried out, for example, under a condition that chemical solution cleaning such as acid/alkaline/detergent cleaning, pure water cleaning, and so on were combined stepwise.

In this manner, the magnetic disk glass substrate 10 was manufactured.

With respect to the obtained glass substrate 10, the number of foreign substances (foreign substances detected to have sizes of 0.1 μm or more and 1.0 μm or less upon detection of scattered light from the substrate 10 when laser light with a wavelength of 405 nm is irradiated with a spot size of 5 μm at a laser power of 25 mW; the same shall apply hereinafter) on each of the surface A 11 and the surface B 12 was counted using the apparatus shown in FIG. 3. As a result, the number of foreign substances present on the surface A 11 was zero per surface and the number of foreign substances present on the surface B 12 was about 300 per surface.

The magnetic disk glass substrate 10 was again subjected to acid cleaning, alkaline cleaning, and pure water cleaning in this order as cleaning before film formation. Thereafter, the number of foreign substances or the like on each of the surface A 11 and the surface B 12 was counted again using the apparatus shown in FIG. 3. As a result, the number of foreign substances present on the surface A 11 was two per surface and the number of foreign substances present on the surface B 12 was about 300 per surface.

Then, an adhesive layer, a soft magnetic layer, a nonmagnetic underlayer, a perpendicular magnetic recording layer, a protective layer, and a lubricating layer were formed in this order on the surface A 11 of the glass substrate 10 and a titanium layer with a thickness of 10 nm was formed as an elution preventing layer on the surface B 12 of the glass substrate 10, thereby manufacturing a magnetic disk.

The surface A 11 of the magnetic disk was subjected to tape burnishing and then head burnishing. In this event, the head burnishing was carried out in the order of outer peripheral end→inner peripheral end→outer peripheral end (r=12.5 mm to 32.0 mm, head center position). Thereafter, the surface of a burnishing head was observed by a microscope to count the number of belt-like foreign substances (smear) on the head. As a result, the number of foreign substances was less than three and the head contamination level was 1.

That is, it has been found that when the number of foreign substances present on the surface B 12 of the glass substrate 10 is set to about 300 per surface, the surface A 11 is hardly contaminated even if the cleaning of the glass substrate 10 is carried out.

### Comparative Example

By changing the cleaning conditions, there was manufactured a magnetic disk glass substrate 10 in which the number of foreign substances present on its surface A 11 was zero per surface and the number of foreign substances present on its surface B 12 was about 500 per surface.

This glass substrate 10 was subjected to acid cleaning, alkaline cleaning, and pure water cleaning in this order as cleaning before film formation. Thereafter, the number of foreign substances on each of the surface A 11 and the surface B 12 was counted using the apparatus shown in FIG. 3. As a result, the number of foreign substances present on the surface A 11 was 10 per surface and the number of foreign substances present on the surface B 12 was about 490 per surface.

Then, like in the Example, an adhesive layer, a soft magnetic layer, a nonmagnetic underlayer, a perpendicular magnetic recording layer, a protective layer, and a lubricating layer were formed in this order on the surface A 11 of the glass substrate 10 and a titanium layer with a thickness of 10 nm was formed as an elution preventing layer on the surface B 12 of the glass substrate 10, thereby manufacturing a magnetic disk.

The surface A 11 of the magnetic disk was subjected to tape burnishing and then head burnishing. In this event, the head burnishing was carried out in the order of outer peripheral end→inner peripheral end→outer peripheral end (r=12.5 mm to 32.0 mm, head center position). Thereafter, the surface of a burnishing head was observed by a microscope to count the number of belt-like foreign substances (smear) on the head. As a result, the number of foreign substances was three or more and less than six and the head contamination level was 2.

The head contamination level was set to level 1 when the surface of a burnishing head was observed by a microscope and the number of belt-like foreign substances (smear) on the head was less than three, to level 2 when it was three or more and less than six, and to level 3 when it was six or more and less than ten.

Then, the magnetic disks obtained in the Example and the Comparative Example were assembled into HDDs, respectively, and a seek test was carried out (counting the number of read/write errors during 40,000,000 times seeking). As a result, the count was 3 for the magnetic disk of the Example and the count was 20 for the magnetic disk of the Comparative Example.

This invention is not limited to the above-mentioned embodiment and can be carried out by appropriately changing it. For example, in the above-mentioned embodiment, the example is shown in which the glass substrate is used as the magnetic disk substrate, but this invention is not limited thereto and use may be made of, for example, a metal plate made of an aluminum-magnesium alloy.

The materials, sizes, processing sequences, inspection methods, and so on in the above-mentioned embodiment are only examples and this invention can be carried out by changing them in various ways within a range capable of exhibiting the effect of this invention. Other than that, this invention can be carried out in various ways within a range not departing from the object of this invention.

What is claimed is:

1. A magnetic disk substrate being annular and having a first and a second main surface,
wherein (1) surface roughness measured by an atomic force microscope having a resolution of 256×256 pixels per 2 μm square and/or (2) the number of foreign substances detected to have sizes of 0.1 μm or more and 1.0 μm or less upon detection of scattered light from said magnetic disk substrate when laser light with a wavelength of 405 nm is irradiated with a spot size of 5 μm at a laser power of 25 mW differ/differs between said first and second main surfaces, and
wherein only said first main surface has a surface quality usable as a magnetic recording surface and the number of the foreign substances detected to have the sizes of 0.1 μm or more and 1.0 μm or less upon detection of the scattered light from said magnetic disk substrate when the laser light with the wavelength of 405 nm is irradiated with the spot size of 5 μm at the laser power of 25mW is 400 or less per 30cm² on said second main surface.

2. A magnetic disk comprising the magnetic disk substrate according to claim 1 and a laminated film including at least a magnetic layer and formed only on said first main surface of said magnetic disk substrate.

3. The magnetic disk according to claim 2, wherein no film is formed on said second main surface.

4. The magnetic disk according to claim 2, wherein an offset film is formed on said second main surface for offsetting a film stress generated when said laminated film is formed on said first main surface.

5. The magnetic disk according to claim 2, wherein
said magnetic disk substrate is made of a multi-component glass, and
an elution preventing film is formed on said second main surface for preventing elution of ions forming said multi-component glass to the surface of said magnetic disk substrate.
